(19) United States
(12) Patent Application Publication
(10) Pub. No.: US 2023/0397275 A1
(43) Pub. Date: Dec. 7, 2023

(54) LINK ACTIVATION AND DEACTIVATION IN MULTILINK DEVICES

(71) Applicants: Laurent Cariou, Milizac (FR); Thomas J. Kenney, Portland, OR (US)

(72) Inventors: Laurent Cariou, Milizac (FR); Thomas J. Kenney, Portland, OR (US)

(21) Appl. No.: 18/234,223

(22) Filed: Aug. 15, 2023

Related U.S. Application Data
(60) Provisional application No. 63/525,545, filed on Jul. 7, 2023.

(51) Int. Cl. H04W 76/15

(52) U.S. Cl. CPC H04W 76/15

(57) ABSTRACT

Methods, apparatuses, and computer readable media for activation and deactivation of links in a multilink device (MLD) where an apparatus of an access point (AP) MLD comprises processing circuitry configured to: encode, for transmission to a non-AP MLD, an advertisement traffic-identification (TID)-to-link mapping, the advertisement TID-to-link mapping indicating a first AP affiliated with the AP MLD is disabled, the first AP associated with a first link of the AP MLD, and decode, from the non-AP MLD, on a second link of the AP MLD, a request to enable the first AP, the second link associated with a second AP. The processing circuitry is further configured to encode, for transmission to the non-AP MLD, a response to the request to enable the first AP. An apparatus of a non-AP MLD is similarly configured.

### PRIORITY CLAIM

This application claims the benefit of priority under 35 USC 119(e) to U.S. Provisional Patent Application Ser. No. 63/525,545, filed Jul. 7, 2023, which is incorporated herein by reference in its entirety.

### TECHNICAL FIELD

Embodiments relate to link activation and deactivation in multilink devices (MLD), in accordance with wireless local area networks (WLANs) and Wi-Fi networks including networks operating in accordance with different versions or generations of the IEEE 802.11 family of standards.

### BACKGROUND

Efficient use of the resources of a wireless local-area network (WLAN) is important to provide bandwidth and acceptable response times to the users of the WLAN without consuming excess power. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments.

FIG. 2 illustrates a front-end module circuitry for use in the radio architecture of FIG. 1 in accordance with some embodiments.

FIG. 3 illustrates a radio IC circuitry for use in the radio architecture of FIG. 1 in accordance with some embodiments.

FIG. 4 illustrates a baseband processing circuitry for use in the radio architecture of FIG. 1 in accordance with some embodiments.

FIG. 5 illustrates a WLAN in accordance with some embodiments.

FIG. 6 illustrates a block diagram of an example machine upon which any one or more of the techniques (e.g., methodologies) discussed herein may perform.

FIG. 7 illustrates a block diagram of an example wireless device upon which any one or more of the techniques (e.g., methodologies or operations) discussed herein may perform.

FIG. 8 illustrates multi-link devices (MLD)s, in accordance with some embodiments.

FIG. 9 illustrates collocated and non-collated MLDs, in accordance with some embodiments.

FIG. 10 illustrates methods link activation and deactivation in multilink devices (MLDs), in accordance with some embodiments.

FIG. 11 illustrates a TID-to-link mapping element, in accordance with some embodiments.

FIG. 12 illustrates a TWT element, in accordance with some embodiments.

FIG. 13 illustrates an ultra-high reliable (UHR) element, in accordance with some embodiments.

FIG. 14 illustrates a method for link activation and deactivation in multilink devices, in accordance with some embodiments.

FIG. 15 illustrates a method for link activation and deactivation in multilink devices, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments relate to methods, computer readable media, and apparatus for adjusting the duration field on CTS frames. Some embodiments relate to methods, computer readable media, and apparatus for responding to adjustments to adjustments to the duration field of CTS frames.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth® (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth® (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth® (BT) connectivity standard such as Bluetooth®, Bluetooth® 4.0 or Bluetooth® 5.0, or any other iteration of the Bluetooth® Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

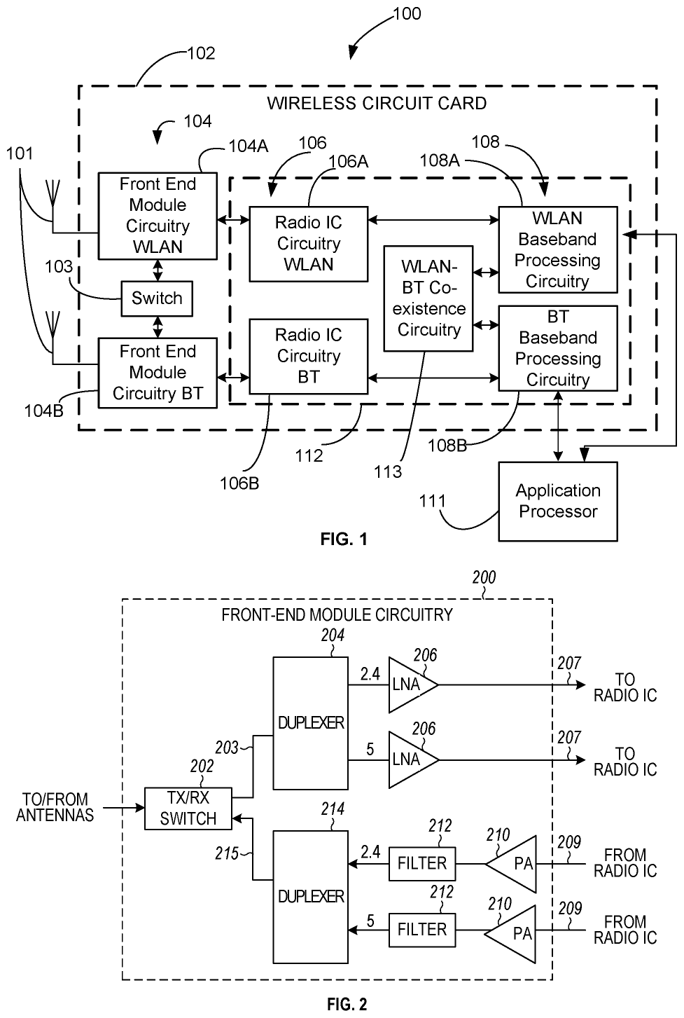

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

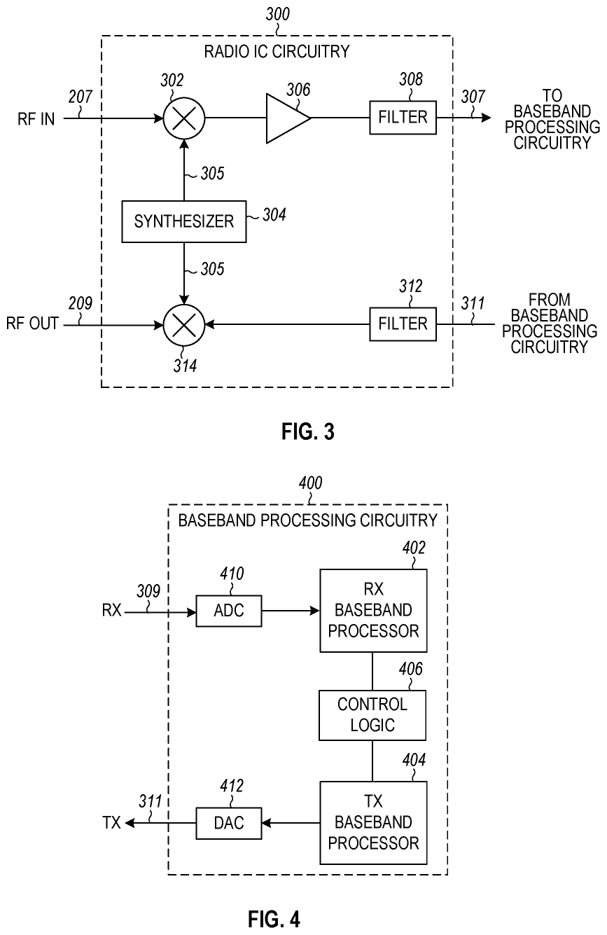

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

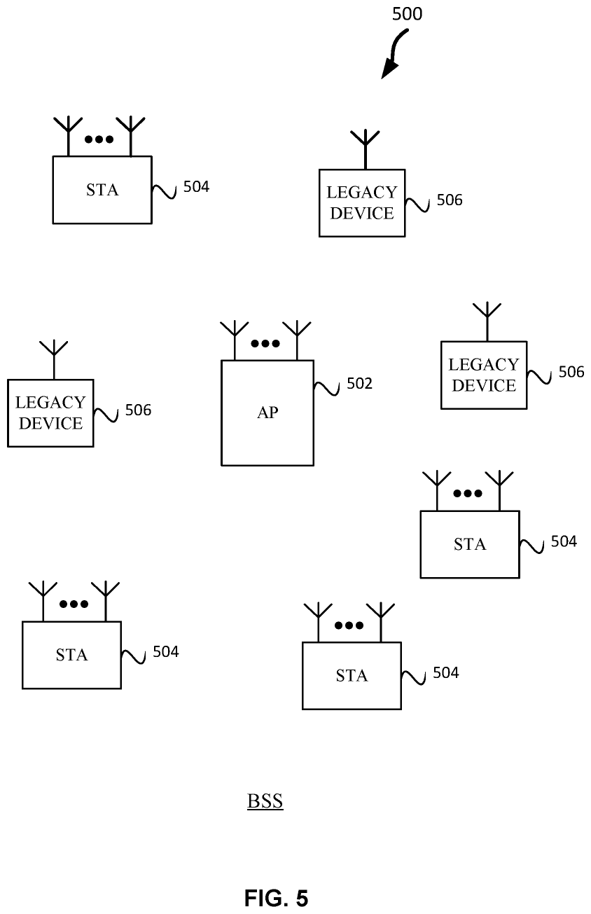

FIG. 5 illustrates a WLAN 500 in accordance with some embodiments. The WLAN 500 may comprise a basis service set (BSS) that may include an access point (AP) AP 502, a plurality of stations (STAs) STAs 504, and a plurality of legacy devices 506. In some embodiments, the STAs 504 and/or AP 502 are configured to operate in accordance with IEEE 802.11be extremely high throughput (EHT) and/or high efficiency (HE) IEEE 802.11ax. In some embodiments, the STAs 504 and/or AP 502 are configured to operate in accordance with IEEE 802.11az. In some embodiments, the STAs 504, APs 502, AP MLDs 808, and/or non-AP MLD 809 are configured to operate in accordance with IEEE P802.11be™/D3.2, May 2023 and/or IEEE P802.11-REVme™/D2.0, October 2022, both of which are hereby included by reference in their entirety.

The AP 502 may be an AP using the IEEE 802.11 to transmit and receive. The AP 502 may be a base station. The AP 502 may use other communications protocols as well as the IEEE 802.11 protocol. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one EHT AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the AP 502 may also be configured to communicate with STAs 504 in accordance with legacy IEEE 802.11 communication techniques.

In some embodiments, a HE or EHT frames may be configurable to have the same bandwidth as a channel. The HE or EHT frame may be a physical Layer Convergence Procedure (PLCP) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE or EHT frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®®, low-power Bluetooth®®, or other technologies.

In accordance with some IEEE 802.11 embodiments, e.g, IEEE 802.11EHT/ax/be embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE or EHT control period, the AP 502 may communicate with STAs 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/ax communication techniques, although this is not a requirement.

In some embodiments the STA 504 may be a “group owner” (GO) for peer-to-peer modes of operation. A wireless device may be a STA 504 or a HE AP 502. The STA 504 may be termed a non-access point (AP)(non-AP) STA 504, in accordance with some embodiments.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE STA 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-15.

In example embodiments, the STAs 504 and/or the AP 502 are configured to perform the methods and operations/functions described herein in conjunction with FIGS. 1-15. In example embodiments, an apparatus of the STA 504 and/or an apparatus of the AP 502 are configured to perform the methods and functions described herein in conjunction with FIGS. 1-15. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP. The AP 502 may be part of a non-collocated AP MLD, e.g., non-collocated AP MLD3 912, collocated AP MLD1 904, or collocated AP MLD2 908. The STAs 504 may be part of a non-AP MLD 809, which may be termed a ML non-AP logical entity. The BSS may be part of an extended service set (ESS), which may include multiple APs and may include one or more management devices. The BSSs in an ESS may communicate with one another and/or may be managed by another device or one or more of the BSSs. Additionally, the ESS may have a gateway, router, or another network device that connects the ESS to other networks such as the internet.

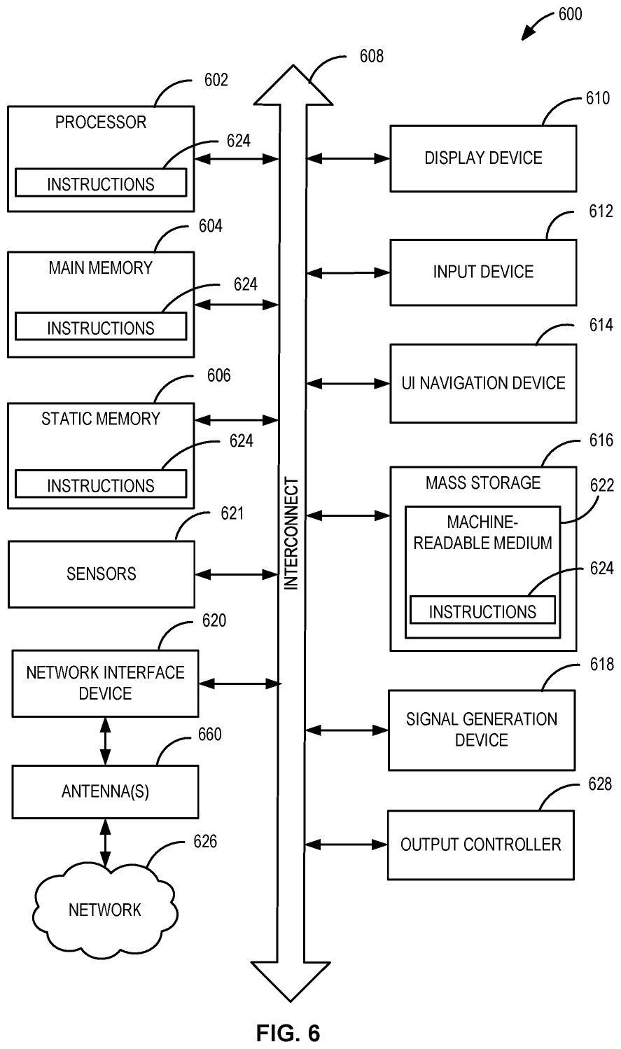

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT STA 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The mass storage 616 device may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the mass storage 616 device may constitute machine readable media.

Specific examples of machine-readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

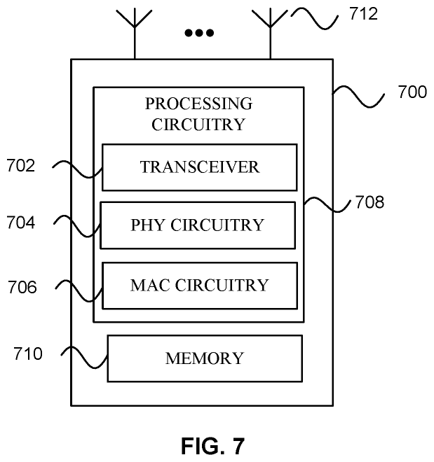

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA 504, HE AP 502, and/or a HE STA or HE AP. A HE STA 504, HE AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP 502, HE STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP 502 and/or HE STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mmWave technology, communication between a station (e.g., the HE STAs 504 of FIG. 5 or wireless device 700) and an access point (e.g., the HE AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

A technical problem is how to communicate with STAs and other devices that may only listen to one frequency band at a time but are associated with more than one frequency band. Some embodiments enable MLDs to ensure that STAs and other wireless devices communicating with the MLD do not miss important fields or elements. Some STAs or other wireless devices communicating with the MLD may be associated with the MLD on several different frequency bands, but only receiving or listening to one frequency band. The MLD and the STA or other wireless device, however, may need to follow procedures communicated on other frequency bands of the MLD. Embodiments include fields or elements transmitted by a first AP of the MLD operating on first frequency band being transmitted by other APs operating on different frequency bands. In this STAs and other wireless devices can follow the procedures, if any, as if the STA or other wireless device received the field or element from the first AP.

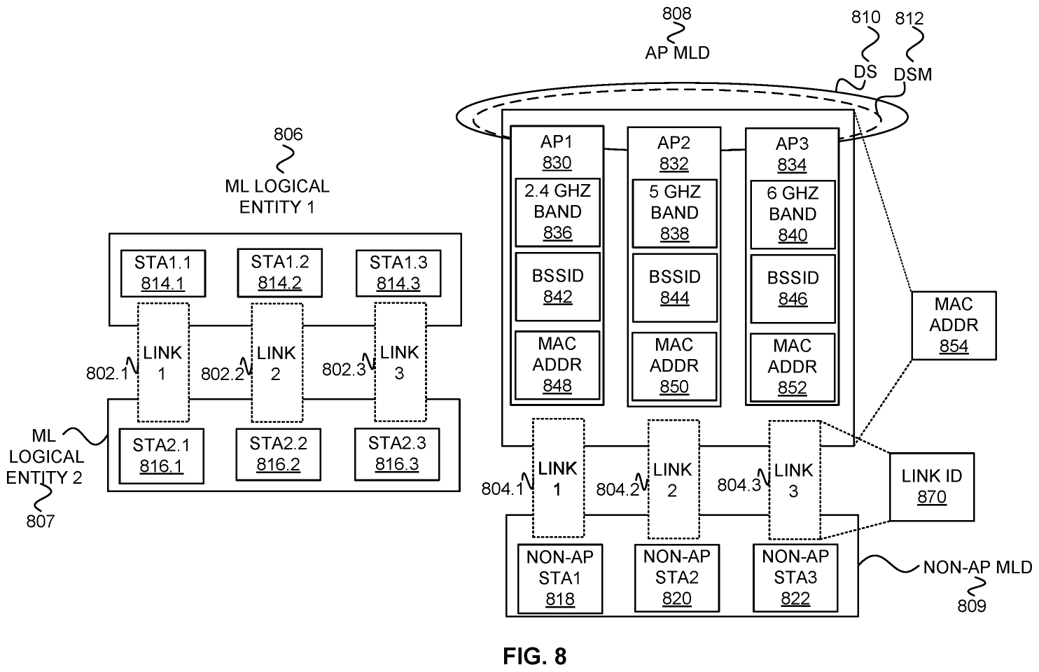

FIG. 8 illustrates multi-link devices (MLD)s 800, in accordance with some embodiments. Illustrated in FIG. 8 is ML logical entity 1 806, ML logical entity 2 807, AP MLD 808, and non-AP MLD 809. The ML logical entity 1 806 includes three STAs, STA1.1 814.1, STA1.2 814.2, and STA1.3 814.3 that operate in accordance with link 1 802.1, link 2 802.2, and link 3 802.3, respectively.

The Links are different frequency bands such as 2.4 GHz band, 5 GHz band, 6 GHz band, and so forth. ML logical entity 2 807 includes STA2.1 816.1, STA2.2 816.2, and STA2.3 816.3 that operate in accordance with link 1 802.1, link 2 802.2, and link 3 802.3, respectively. In some embodiments ML logical entity 1 806 and ML logical entity 2 807 operate in accordance with a mesh network. Using three links enables the ML logical entity 1 806 and ML logical entity 2 807 to operate using a greater bandwidth and more reliably as they can switch to using a different link if there is interference or if one link is superior due to operating conditions.

The distribution system (DS) 810 indicates how communications are distributed and the DS medium (DSM) 812 indicates the medium that is used for the DS 810, which in this case is the wireless spectrum.

AP MLD 808 includes AP1 830, AP2 832, and AP3 834 operating on link 1 804.1, link 2 804.2, and link 3 804.3, respectively. AP MLD 808 includes a MAC address 854 that may be used by applications to transmit and receive data across one or more of AP1 830, AP2 832, and AP3 834. Each link may have an associated link ID. For example, as illustrated, link 3 804.3 has a link ID 870.

AP1 830, AP2 832, and AP3 834 includes a frequency band, which are 2.4 GHz band 836, 5 GHz band 838, and 6 GHz band 840, respectively. AP1 830, AP2 832, and AP3 834 includes different BSSIDs, which are BSSID 842, BSSID 844, and BSSID 846, respectively. AP1 830, AP2 832, and AP3 834 includes different media access control (MAC) address (addr), which are MAC adder 848, MAC addr 850, and MAC addr 852, respectively. The AP 502 is a AP MLD 808, in accordance with some embodiments. The STA 504 is a non-AP MLD 809, in accordance with some embodiments.

The non-AP MLD 809 includes non-AP STA1 818, non-AP STA2 820, and non-AP STA3 822. Each of the non-AP STAs may be have MAC addresses and the non-AP MLD 809 may have a MAC address that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, or AP3 834, respectively, over link 1 804.1, link 2 804.2, and link 3 804.3, respectively.

A Multi-link device such as ML logical entity 1 806 or ML logical entity 2 807, is a logical entity that contains STA1.1 814.1, STA1.2 814.2, STA1.3 814.3, STA2.1 816.1, STA2.2 816.2, and STA2.3 816.3. The ML logical entity 1 806 and ML logical entity 2 807 each has one MAC data service interface and primitives to the logical link control (LLC) and a single address associated with the interface, which can be used to communicate on the DSM 812. Multi-link logical entity allows STAs within the multi-link logical entity to have the same MAC address. In some embodiments a same MAC address is used for application layers and a different MAC address is used per link.

In infrastructure framework, AP MLD 808, includes APs 830, 832, 834, on one side, and non-AP MLD 809, which includes non-APs STAs 818, 820, 822 on the other side.

ML AP device (AP MLD): is a ML logical entity, where each STA within the multi-link logical entity is an EHT AP 502, in accordance with some embodiments. ML non-AP device (non-AP MLD) A multi-link logical entity, where each STA within the multi-link logical entity is a non-AP EHT STA 504. AP1 830, AP2 832, and AP3 834 may be operating on different bands and there may be fewer or more APs. There may be fewer or more STAs as part of the non-AP MLD 809.

In some embodiments the AP MLD 808 is termed an AP MLD or MLD. In some embodiments non-AP MLD 809 is termed a MLD or a non-AP MLD. Each AP (e.g., AP1 830, AP2 832, and AP3 834) of the MLD sends a beacon frame that includes: a description of its capabilities, operation elements, a basic description of the other AP of the same MLD that are collocated, which may be a report in a Reduced Neighbor Report element or another element such as a basic multi-link element. AP1 830, AP2 832, and AP3 834 transmitting information about the other APs in beacons and probe response frames enables STAs of non-AP MLDs to discover the APs of the AP MLD.

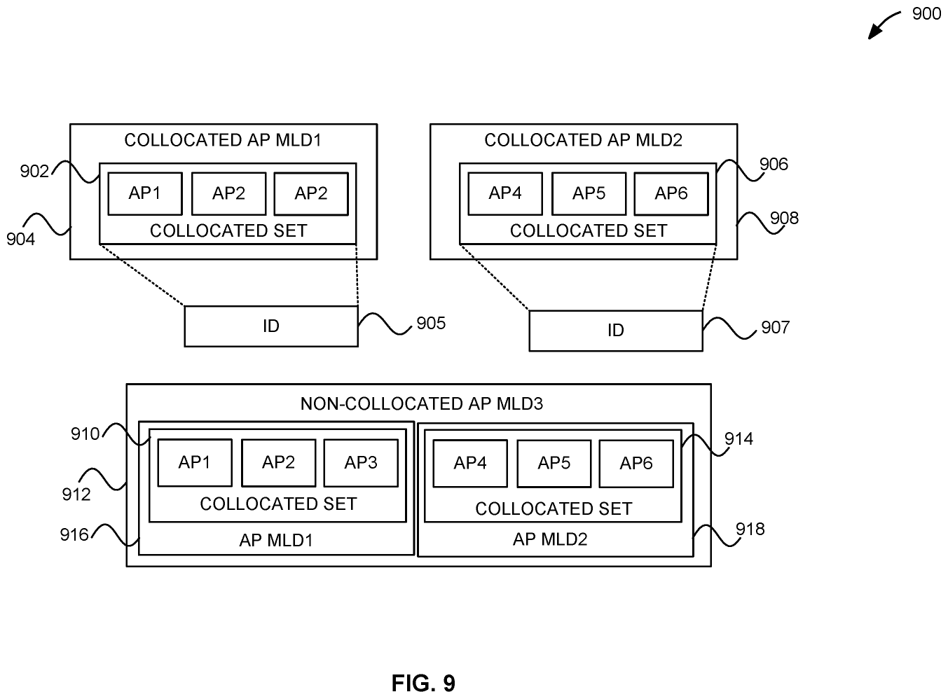

FIG. 9 illustrates collocated and non-collated MLDs, in accordance with some embodiments. The collocated AP MLD1 904 includes a collocated set 902 of APs, which are AP1, AP2, and AP3. The collocated AP MLD2 908 includes a collocated set 906 of APs, which are AP4, AP5, and AP6. The collocated AP MLD1 904 and collocated AP MLD1 908 are AP MLD 808 and/or MLDs as disclosed in conjunction with IEEE P802.11be™/D3.0, January 2023, in accordance with some embodiments. The AP1 . . . AP6 may be the same or similar as AP 502. The collocated set 902 may have an ID 905 and the collocated set 906 may have an ID 907. The ID 905 and ID 907 may be used as part of the identification of the AP in the field collocated set ID or collocated AP MLD ID.

The non-collocated AP MLD3 912 comprises AP MLD1 916, which comprises collocated set 910, and AP MLD2 918, which comprises collocated set 914. The non-collocated AP MLD3 912 may be as disclosed in conjunction with IEEE P802.11be™/D3.2, May 2023 (“IEEE 802.11be”) or Wi-Fi 8, in accordance with some embodiments. As an example, AP MLD1 916 and AP MLD2 918 may be implemented on separate electronic devices and may be separated physically from one another. The non-collocated AP MLD3 may include hundreds or more AP MLDs. APs 502 such as AP1, AP2, AP6 may be termed as affiliated if they are associated with the same MLD.

Enterprise planned BSSs may be termed ESSs, Wi-Fi deployments, networks, or other terms may be used. Enterprise planned Wi-Fi deployments are developed to achieve some level of frequency reuse to increase total system throughput. The reuse factor or spatial reuse (SR) factor is the rate at which the same carrier frequency can be reused within the network deployment. A reuse factor, which may be termed K, of 1 means that all APs in the network can reuse any frequency. The number of cells which cannot use the same frequencies is indicated by K. For example, if K is three, then every third cell can reuse the frequency and two cells cannot. In some embodiments, the spatial reuse factor is a ratio between the BSS transmit/receive radius (R) and the distance between APs on a same channel (D).

A technical problem is how to increase the reuse factor, which tends to improve the overall throughput of the network. Due to interference, achieving a reuse factor, K, of 1 is very difficult. Furthermore, in the case of Wi-Fi or IEEE 802.11 with multiple transmissions bandwidths as options, e.g., 20 MHz to 320 MHz, increasing the frequency reuse factor allows each AP to use a larger bandwidth without interference from a nearby AP. Some Wi-Fi enterprise planned deployments use a frequency reuse factor of between 7 to 9.

In some embodiments, APs at a certain distance from each other (the reuse factor) reduce their transmit power or desense their receivers (reduce their minimum sensitivity) to increase spatial reuse. This mechanism may be used to get some level of reuse in an area. In these embodiments, there is no coordination between APs, except for occasional transmit power or receiver desense adjustments. Each AP is performs normal Enhanced Distributed Channel Access (EDCA), and the spatial reuse is achieve by transmit power (TX power) adjustments, e.g., lowering the TX power and/or raising the value of the received signal strength indicator (RSSI) before a signal is considered to have been received.

Some embodiments use AP coordination to achieve SR gains with a lower reuse factor. In some embodiments, spatial reuse factor is defined as the ratio between the BSS transmit/receive radius (R) and the distance between AP's on the same channel (D). In some embodiments, the spatial reuse factors is less than 0.2 with field experience demonstrating that this provides some level of network throughput gains.

APs 502, STAs 504, non-AP MLDs 809, AP MLDs 808, as well as other network equipment consumes greater power with the greater complexity in features and hardware/software design. A technical challenge is how to reduce the power consumption within the non-AP MLDs 809 and AP MLDs 808.

In some embodiments, mechanisms for power save are disclosed using traffic identification (TID)-to-link mappings 1002 and advertised TID-to-link mappings 1002. A TID-to-link mapping 1002 specifies the mapping of TIDs to the different links 804 for a non-AP MLD 809. A link is disabled if no TIDs are mapped to the link and enabled if at least one TID is mapped to the link. TID-to-link mappings 1004 can be negotiated for each non-AP MLD 809 with its associated AP MLD 808.

Advertised TID-to-link mapping 1002 allows the AP 502 or AP MLD 808 to include in the Beacon frames that it transmits a TID-to-link mapping 1002 which is adopted on all associated non-AP MLDs 809. The AP MLD 808 can configure the advertised TID-to-link mapping 1002 so that some links 804 are disabled for all associated non-AP MLDs 809. All associated non-AP MLDs 809 will update their TID-to-link mapping 1004 to consider the link 804 as disabled and no frame exchange is permitted with the AP MLD 808 on the disabled link 804 so that the AP, e.g. AP1 830, AP2 832, or AP3 834, on link 1 804.1, link 2 804.2, or link 804.3, respectively, can go in doze state or be unavailable and save power.

For example, at night in a home environment where an AP MLD 808 with three APs, AP1 830, AP2 832, or AP3 834, operating on 2.4, 5 and 6 GHz, respectively, are active during the day, and then at night the AP MLD 808 configures advertised TID-to-link mapping 1002 so that only the 2.4 GHz AP1 830 will stay active on link 1 804.1 and AP2 832 and AP3 834 operating on link 2 804.2 at 5 GHz and link 3 804.3 operating on 6 GHz are disabled.

With this configuration of AP MLD 808, non-AP MLDs 809 or STAs 504 that need to keep an AP active during the night (typically IoT devices) being largely connected at 2.4 GHz, such services are preserved on AP1 830 operating on 2.4 GHz on link 1 804.1, and high throughput links, e.g., link 2 804.2 and link 3 804.3, dedicated to more intensive communication needs such as laptops, smartphones, and so forth. The AP MLD 808 may assign or negotiate separate TID-to-link mappings 1002 with each non-AP MLD 809 and/or STA 504 of the non-AP MLD 809.

In some embodiments, the AP MLD 808 advertises TID-to-Link mapping 1002 where the non-AP MLD 809 are required to observe the advertised TID-to-link mapping 1002. In some embodiments, the non-AP MLD 809 can negotiate or request that the TID-to-link mapping 1002 be changed.

In some embodiments, non-AP MLDs 809 and/or STAs 504 can request different TID-to-link mappings 1004. For example, a non-AP MLD 809 needs higher throughput and/or capacity to service a client device such as a smart phone streaming video. The non-AP MLD 809 may request a different TID-to-link mapping 1004, which may enable one or more links 804 that are currently disabled and/or disable one or more links 804 that are currently enabled. The signaling to change the TID-to-link mapping 1002, by both the AP MLD 808 and the non-AP MLD 809, may enable the AP MLD 808 to maintain one or more APs, such as AP1 830, AP2 832, or AP3 834, of the AP MLD 808 in power save mode. The AP MLD 808 may put an AP in power save mode by disabling the corresponding link and the non-AP MLD 809 may request that a link be enabled, which takes the AP out of power save mode. Power save mode may be more important for soft or mobile AP MLDs 808, which may be mobile device with limited power capabilities such as battery. Additionally, there is a demand to reduce power used by AP MLDs 808 and/or non-AP MLDs 809.

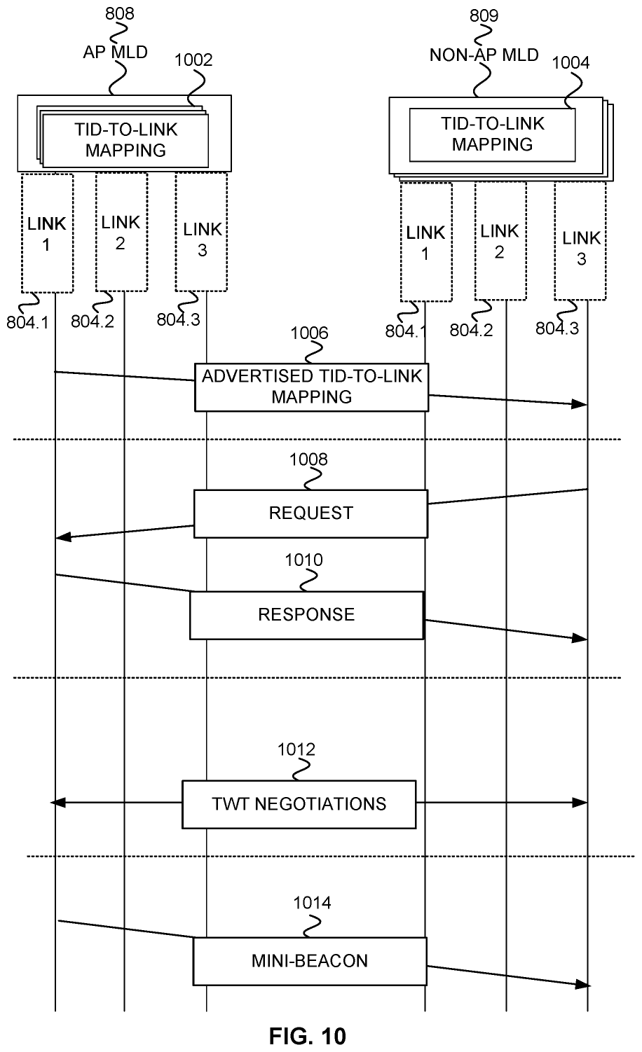

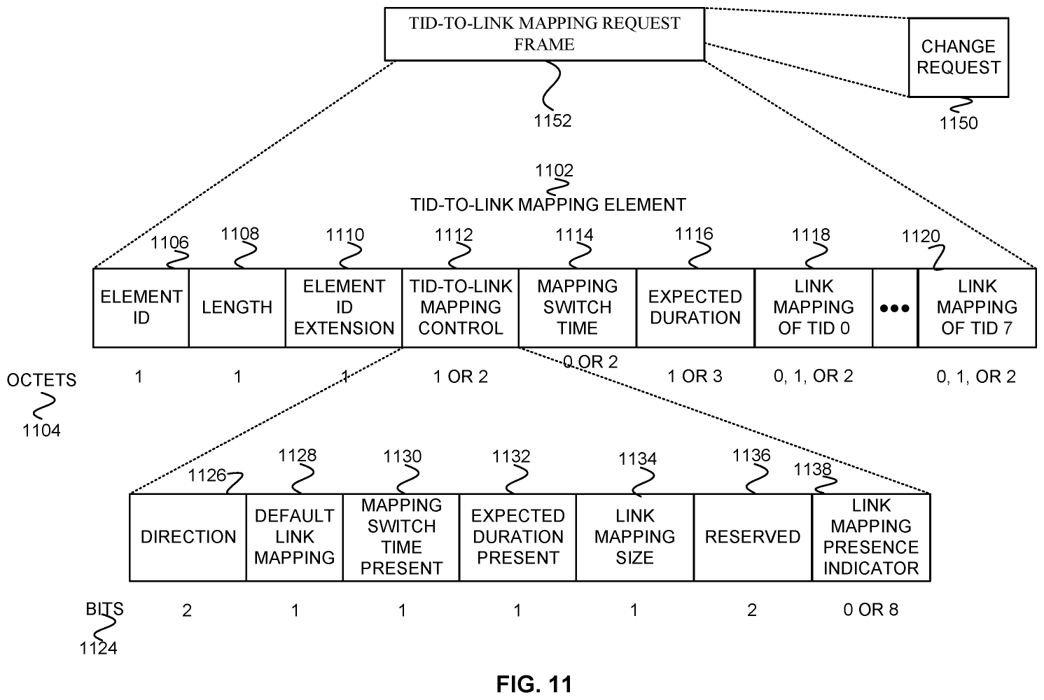

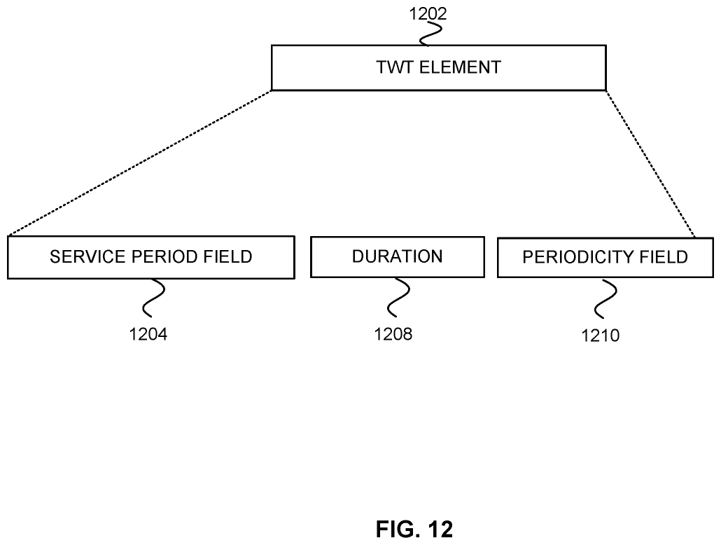

FIG. 10 illustrates methods link activation and deactivation in multilink devices (MLDs), in accordance with some embodiments. FIG. 11 illustrates a TID-to-link mapping element 1102, in accordance with some embodiments. FIG. 12 illustrates a TWT element 1202, in accordance with some embodiments. The TWT element 1202 and/or the TID-to-link mapping element 1102 may be different elements or frames. The TWT element 1302 describes the TWT SP. The schedule of the SP is computed based on the timing synchronization function (TSF) of the AP that sends the frame. The service period field 1204, duration 1208, and periodicity field 1210 indicate one or more SPs.

FIG. 11 illustrates a TID-to-Link mapping element 1102, in accordance with some elements. The TID-to-Link mapping element 1102 comprises an element ID 1106 field, length 1108 field, element ID extension 1110 field, TID-TO-LINK mapping control 1112 field, mapping switch time 1114 field, expected duration 1116 field, and link mapping of TID 0 1118 field through link mapping of TID 7 1120 field. Octets 1104 indicates a number of octets of the field.

The TID-to-link mapping control 1112 field comprises direction 1126 field, default link mapping 1128 field, mapping switch time present 1130 field, expected duration present 1132 field, link mapping size 1134 field, reserved 1136 field, and link mapping presence indicator 1138 field. Bits 1124 indicates a number of bits of each field. One or more of the fields may be as disclosed in IEEE P802.11be™/D3.2, May 2023.

In some embodiments, the AP MLD 808 transmits an advertised TID-to-link mapping 1006 to one or more non-AP MLDs 809. The advertised TID-to-link mapping 1006 may be included in a beacon frame or another frame. The advertised TID-to-link mapping 1006 may be a frame or element such as TID-to-Link mapping element 1102. The non-AP MLDs 809 decode the advertised TID-to-link mapping 1006 and operate in accordance with the TID-to-link mapping 1006.

The AP MLD 808 may disable links 804 by not assigning TIDs to the links 804. The associated non-AP MLDs 809 will update their TID-to-link mapping 1004 and treat a link 804 with no TIDs assigned to the link 804 as a disabled link 804. The AP MLD 808 and non-AP MLD 809 do not exchange frames over the disabled links 804 (or links 804 with no TIDs assigned to them in TID-to-link mapping 1002), in accordance with some embodiments. The AP1 830, AP2 832, and/or AP3 834 can then be put into a power save mode as it is disabled in that it is not serving any TIDs for the AP MLD 808. The AP MLD 808 may be non-collocated AP MLD3 912 or a collocated AP MLD1 904.

For example, AP MLD 808 may assign all TIDs in the TID-to-link mapping 1002 (which may be transmitted in an advertised TID-to-link mapping 1006) to AP1 830 (2.4 GHz), which enables AP2 832 (5 GHz) and AP3 834 (6 GHz) to enter a power save mode. The AP MLD 808 may enter AP2 832 and AP3 834 enter power save mode during periods of low or no usage such as at night. AP1 830 may be configured to handle traffic such as IoT devices.

In some embodiments, the non-AP MLD 809 requests that a disabled link be reenabled. For example, the non-AP MLD 809 may have a need during the period of time where a link is disabled, for some extra capacity where a non-AP MLD 809 requires higher throughput and/or capacity.

In some embodiments, the non-AP MLD 809 transmits an element, frame, and/or packet that indicates a requested TID-to-link mapping 1004 and/or one or more APs, e.g., AP1 830, AP2 832, and/or AP3 834, or links 804, e.g., link 1 804.1, link 2 804.2, and/or link 3 804.3, to be enabled (or to have a new TID mapping or to be disabled) and/or to include a TID mapping to the link.

In some embodiments, the Request 1008 frame is a TID-To-Link Mapping Request frame, which includes a TID-to-link mapping 1004 element. The request 1008 may be a different element, a new frame (just for this type of request), or another type of packet or frame. In some embodiments, the TID-to-link mapping Request frame is used as the request 1008. The TID-to-link mapping request frame 1152 may include a field such as change request 1150 to indicate that this request is for a change of an existing advertised TID-to-link mapping 1002.

The explicit signaling, e.g., field change request 1150, may be a simple flag (1-bit field) using one reserved bit in the TID-to-link control field, called for instance: request for advertised TID-to-link mapping change. For example, a bit of reserved 1136.

In some embodiments, the request 1008 is a TID-to-link mapping request frame 1152 and the AP MLD 808 determines that it is a request to enable an AP or to change the TID-to-Link mapping because the TID-to-Link mapping within the request 1008 is different than the TID-to-Link mapping 1002 that was included in the advertised TID-to-Link mapping 1006.

In some embodiments, in the request 1008 frame, which may be the TID-to-link mapping request frame 1152, that the TID-to-link mapping element 1102 in the Request 1008 frame, includes a new proposed mapping by having all TIDs get mapped to a link that is currently disabled by the advertised TID-to-link mapping 1006. In some embodiments, the TID-to-link mapping element 1102 maps the desired TID to link that the non-AP MLD 809 would like. The TID to link mapping may be incomplete and include a TID to a link that is current disabled or does not have a TID mapped to the link.

In some embodiments, modified elements or additional elements are included in the request 1008 frame that describe the requested usage, e.g., high throughput applications, real-time application, and so forth. The description may include a Quality of Service (QoS) characteristics element. The AP MLD 808 may determine a new TID-to-link mapping 1002 based on the description of the requested usage.

In some embodiments, the request 1008 frame includes a requested duration. For example, the non-AP MLD 809 or one of the STAs may be aware of this information (using the Expected Duration subfield), or even a service period if it is known to the STA by including fields to describe the requested service period, like for instance a target wake time (TWT) element 1202.

The AP MLD 808 decodes the request 1008 frame. The AP MLD 808 transmits a response 1010 frame, in accordance with some embodiments. The response 1010 frame may be a new frame, a TID-to-link mapping request or response frame, an advertised TID-to-link mapping 1006 frame, a new elements, TWT frame, or another type of response. The AP MLD 808 may change the advertised TID-to-link mapping 1006 to enable the link as indicated in the request 1008 frame. In some embodiments, the AP MLD 808 does not enable the requested link, and either does not enable any disabled link, or enables a different link then requested. In some embodiments, the AP MLD 808 indicates any change by sending another advertised TID-to-link mapping 1006. In some embodiments, the response 1010 is an acknowledgement of receiving the request 1008 frame.

The AP MLD 808 may not update the advertised TID-to-Link mapping 1006. For example, the AP MLD 808 may be a soft AP that AP is currently in a critical power state, e.g., the battery is nearly exhausted, currently limited, or there is no excess power to continue operation.

In some embodiments, the AP MLD 808 and non-AP MLD 809 engage in TWT negotiations 1012 with frame exchanged on an enabled link, e.g., a TID is assigned to the link 804 in the advertised TID-to-link mapping 1006, to describe a service period, e.g., indicated in the service period field 1204, which may have a duration indicated by a duration 1208 field and a periodicity indicated by a periodicity field 1210, for operation on another link 804 that is currently advertised by the AP MLD 808 as being disabled.

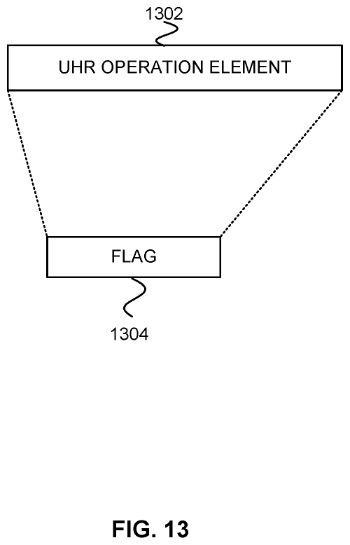

TWT negotiations 1012 may be on one link 804 for another link 804, which may be disabled. The AP MLD 808 may send an acceptance of a proposed SP for a link 804 in response to a TWT element 1202. FIG. 13 illustrates an ultra-high reliable (UHR) element 1302, in accordance with some embodiments. In some embodiments, in order to enable negotiations for a disabled link 804, e.g., using TWT negotiations 1012, a flag 1304 is used to indicate that negotiations are permitted for disabled links.

The UHR operation element 1302 may indication operation parameters for UHR operation. If the flag 1304 is set, then the AP MLD 808 allows STAs of the non-AP MLD 809 and APs of the AP MLD 808 to request and negotiate TWT operation, e.g., TWT negotiations 1012, on a disabled link.

If the negotiation is successful, e.g., TWT negotiations 1012, then the AP for that link 804 will be active and available during the TWT SP for that STA, and will be unavailable elsewhere, in accordance with some embodiments. Other STAs may not be able to use the disabled link during the TWT SP, in accordance with some embodiments.

In some embodiments, the AP or AP MLD 808 does not transmit beacon frames on the disabled link during the TWT SP. In some embodiments, the AP or AP MLD 808 transmits mini-Beacon 1014 frames that would be individually or group addressed to the STA, which is part of the TWT SP negotiation, at the beginning of each TWT SP and that would contain only the dynamic parameters that are needed for operation such traffic indicator map (TIM) element, and so forth. Alternatively, that mini-beacon 1014 frame would be sent at the TBTT (target Beacon frame transmission time) instead of a Beacon frame (especially if there are more than one STA that is having a TWT SP with the disabled link 804.) In this way, the AP or AP MLD 808 may have operation on such the disabled link (with TWT SPs) within TWT SPs.

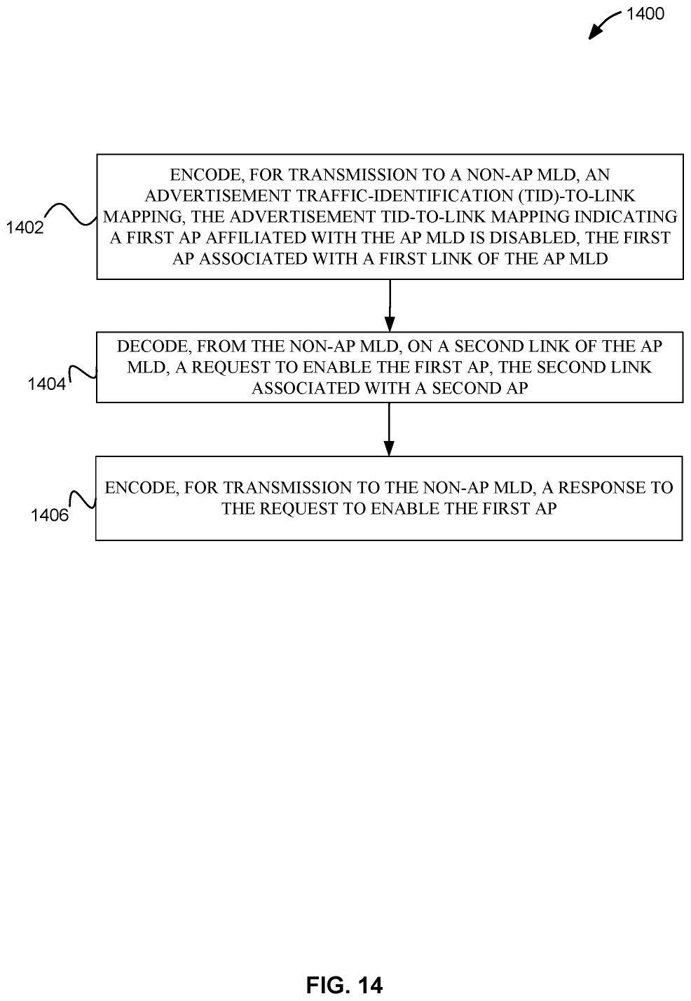

FIG. 14 illustrates a method 1400 for link activation and deactivation in multilink devices, in accordance with some embodiments. The method 1400 begins at operation 1402 with encoding, for transmission to a non-AP MLD, an advertisement traffic-identification (TID)-to-link mapping, the advertisement TID-to-link mapping indicating a first AP affiliated with the AP MLD is disabled, the first AP associated with a first link of the AP MLD. For example, AP MLD 808 may encode for transmission the advertised TID-to-link mapping 1006, which may indicate that a link 804 is disabled. For example, AP2 832 or AP3 834 on link 2 804.2 or link 3 804.3, respectively, may be indicated as disabled because there are no TIDs assigned to the link.

The method 1400 continues at operation 1404 with decoding, from the non-AP MLD, on a second link of the AP MLD, a request to enable the first AP, the second link associated with a second AP. For example, the AP MLD 808 may decode request 1008, from non-AP MLD 809, on link 1 804.1.

The method 1400 continues at operation 1406 with encoding, for transmission to the non-AP MLD, a response to the request to enable the first AP. For example, as disclosed in conjunction with FIG. 10, the AP MLD 808 may encode response 1010 and transmit it to non-AP MLD 809.

The method 1400 may be performed by an apparatus of an AP, an apparatus of an AP of a MLD, or another device. The method 1400 may include one or more additional instructions. The method 1400 may be performed in a different order. One or more of the operations of method 1400 may be optional.

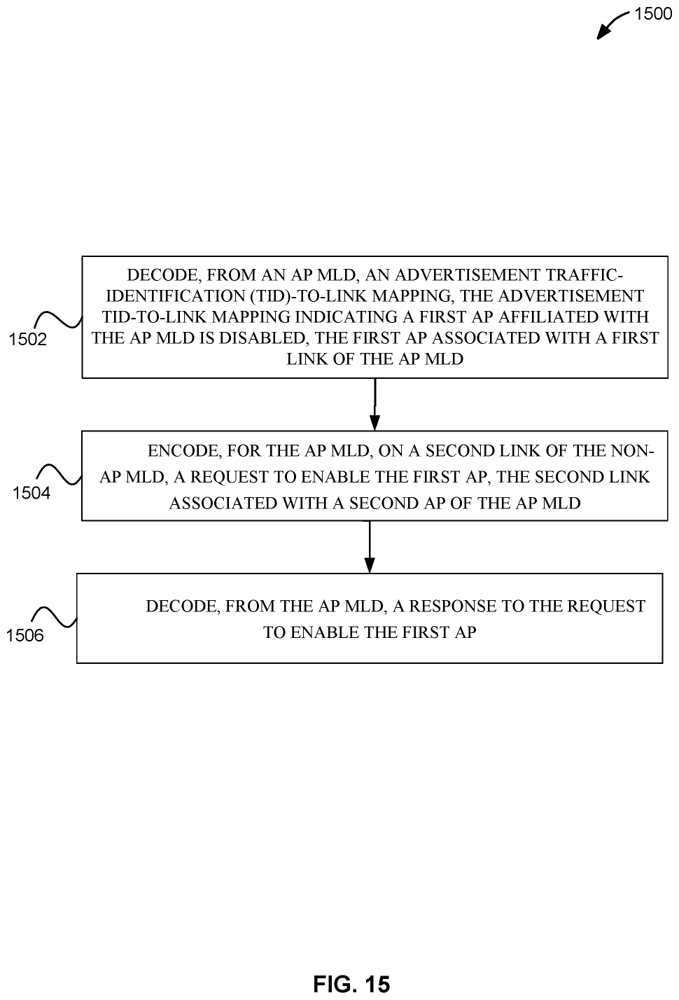

FIG. 15 illustrates a method 1500 for link activation and deactivation in multilink devices, in accordance with some embodiments. The method 1500 may begin at operation 1502 with decoding, from an AP MLD, an advertisement traffic-identification (TID)-to-link mapping, the advertisement TID-to-link mapping indicating a first AP affiliated with the AP MLD is disabled, the first AP associated with a first link of the AP MLD. For example, as disclosed in conjunction with FIG. 10, non-AP MLD 809 may decode advertised TID-to-link mapping 1006.

The method 1500 continues at operation 1504 with encoding, for the AP MLD, on a second link of the non-AP MLD, a request to enable the first AP, the second link associated with a second AP of the AP MLD. For example, non-AP MOD 809 may encode request 1008 for transmission to the AP MLD 808.

The method 1500 continues at operation 1506 with decoding, from the AP MLD, a response to the request to enable the first AP. For example, non-AP MLD 809 may decode response 1010 from the AP MLD 808.

The method 1500 may be performed by an apparatus of an STA, an apparatus of a non-AP MLD, or another device. The method 1500 may include one or more additional instructions. The method 1500 may be performed in a different order. One or more of the operations of method 1500 may be optional.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for an access point (AP) multi-link device (MLD)(AP MLD), the apparatus comprising memory; and processing circuitry coupled to the memory, the processing circuitry configured to:
encode, for transmission to a non-AP MLD, an advertisement traffic-identification (TID)-to-link mapping, the advertisement TID-to-link mapping indicating a first AP affiliated with the AP MLD is disabled, the first AP associated with a first link of the AP MLD;
decode, from the non-AP MLD, on a second link of the AP MLD, a request to enable the first AP, the second link associated with a second AP; and
encode, for transmission to the non-AP MLD, a response to the request to enable the first AP.

2. The apparatus of claim 1, wherein the TID-to-link mapping indicates the first AP is disabled by indicating that no TIDs are mapped to the first AP.

3. The apparatus of claim 1, wherein the request comprises an indication of a request for a TID to be mapped to the first link.

4. The apparatus of claim 1, wherein the request comprises a TID-to-link mapping, the TID-to-link mapping comprising a field indicating the TID-to-link mapping is a request to change a current TID-to-link mapping.

5. The apparatus of claim 1, wherein the request comprises a TID-to-link mapping, and wherein the processing circuitry is further configured to:
in response to the TID-to-link mapping being different than the advertisement TID-to-link mapping, assigning a TID to the first link.

6. The apparatus of claim 1, wherein the request comprises a target wake time (TWT) element, the TWT element comprising a service period field, the service period field indicating a time for the first link to be active for the non-AP MLD.

7. The apparatus of claim 6, wherein the TWT element is a first TWT element, and wherein the response comprises a second TWT element indicating acceptance of the time.

8. The apparatus of claim 6, wherein the request further comprises an indication of a TID-to-link mapping.

9. The apparatus of claim 6, wherein the processing circuitry is further configured to:
encode, for transmission to the non-AP MLD at a start of the time on the first link, a beacon frame, the beacon frame comprising a traffic indicator map (TIM) element.

10. The apparatus of claim 6, wherein the processing circuitry is further configured to:
encode, for transmission to the non-AP MLD at a target beacon transmission time on the first link, a beacon frame, the beacon frame comprising a traffic indicator map (TIM) element.

11. The apparatus of claim 1, wherein the response is an acknowledgement of the request.

12. The apparatus of claim 1, wherein the non-AP MLD is one of a plurality of non-AP MLDs associated with the AP MLD.

13. The apparatus of claim 1, wherein the request and response are part of a target wake time (TWT) negotiation, the TWT negotiation determining a TID to assign to link one and a time a duration for the TID to be assigned to link one.

14. The apparatus of claim 1, wherein the AP MLD is a non-collocated AP MLD.

15. A non-transitory computer-readable storage medium that stores instructions for execution by one or more processors of an access point (AP) multi-link device (MLD)(AP MLD), the instructions to configure the one or more processors to:
encode, for transmission to a non-AP MLD, an advertisement traffic-identification (TID)-to-link mapping, the advertisement TID-to-link mapping indicating a first AP affiliated with the AP MLD is disabled, the first AP associated with a first link of the AP MLD;
decode, from the non-AP MLD, on a second link of the AP MLD, a request to enable the first AP, the second link associated with a second AP; and
encode, for transmission to the non-AP MLD, a response to the request to enable the first AP.

16. The non-transitory computer-readable storage medium of claim 15, wherein the TID-to-link mapping indicates the first AP is disabled by indicating that no TIDs are mapped to the first AP.

17. The non-transitory computer-readable storage medium of claim 15, wherein the request comprises an indication of a request for a TID to be mapped to the first link.

18. An apparatus for a non-access point (AP) multi-link device (MLD)(non-AP MLD), the apparatus comprising memory; and processing circuitry coupled to the memory, the processing circuitry configured to:
decode, from an AP MLD, an advertisement traffic-identification (TID)-to-link mapping, the advertisement TID-to-link mapping indicating a first AP affiliated with the AP MLD is disabled, the first AP associated with a first link of the AP MLD;
encode, for the AP MLD, on a second link of the non-AP MLD, a request to enable the first AP, the second link associated with a second AP of the AP MLD; and
decode, from the AP MLD, a response to the request to enable the first AP.

19. The apparatus of claim 18, wherein the TID-to-link mapping indicates the first AP is disabled by indicating that no TIDs are mapped to the first AP.

20. The apparatus of claim 1, wherein the request comprises an indication of a request for a TID to be mapped to the first link.
